(19) United States
(12) Patent Application Publication
(10) Pub. No.: US 2024/0296077 A1
(43) Pub. Date: Sep. 5, 2024

(54) Storage Assignment Using Application Storage Requirements

(71) Applicant: International Business Machines Corporation, Armonk, NY (US)

(72) Inventors: Neeraj Kumar Kashyap, Bengaluru (IN); Sandip Amin, Austin, TX (US)

(21) Appl. No.: 18/177,831

(22) Filed: Mar. 3, 2023

(51) Int. Cl. G06F 9/50; G06F 9/455

(52) U.S. Cl. CPC G06F 9/5077; G06F 9/45558; G06F 2009/45583

(57) ABSTRACT

A computer implemented method manages storage. A number of processor units receive a request for a storage for an application. The number of processor units identify application storage requirements for the application in response to receiving the request for the storage for the application. The number of processor units identify a storage profile based on the application storage requirements in the request. The storage profile describes the storage for use by the application. The number of processor units returns the storage having the profile for use by the application to access the storage.

### BACKGROUND

The disclosure relates generally to an improved computer system and more specifically to assigning storage based on application storage requirements.

In different computing environments, different types of storage can be available for use by applications in a container environment such as a container orchestration platform. The container orchestration platform can be configured with persistent storage volumes for use by applications deployed in containers in the platform.

With a container orchestration platform managed by a cloud provider, the provider often deploys a default storage solution to provide persistent storage. With a distributed hybrid cloud, the multiple persistent storage volume choices are present. With a hybrid cloud architecture, the customer takes responsibility for selecting and deploying a suitable storage solution to provide persistent storage for workloads for applications operating in containers in an orchestration retainer platform.

For example, software defined storage (SDS) solutions can be present along with provider hosted storage services for use by the customer. As another example, a customer may have multiple choices for block storage. For example, the customer may have the ability to select from various sources of block storage. With the large number of storage options, it can be challenging for a customer to select a suitable storage option or options that will meet the workload and service level objectives for applications deployed in container environments.

### SUMMARY

According to one illustrative embodiment, a computer implemented method manages storage. A number of processor units receives a request for a storage for an application. The number of processor units identifies application storage requirements for the application in response to receiving the request for the storage for the application. The number of processor units identifies a storage profile based on the application storage requirements in the request. The storage profile describes the storage for use by the application. The number of processor units returns the storage having the profile for use by the application to access the storage. According to other illustrative embodiments, a computer system and a computer program product for managing storage are provided. As a result, the illustrative embodiments can provide a technical effect of increasing the performance in providing storage that meets storage requirements and service level objectives.

The illustrative embodiments can permissively create a new storage meeting the application storage requirements in response to an absence of the storage profile meeting the application storage requirements and create a new storage profile meeting the application storage requirements in response to an absence of the storage profile meeting the application storage requirements. As a result, the illustrative embodiments can provide a technical effect of increasing the performance in providing storage to meet storage requirements and service level objectives through providing customized storage based on storage requirements in response to current storage not meeting the storage requirements in the request.

In identifying the storage profile based on the application storage requirements in the request, the illustrative embodiments can permissively predict a storage class using the application storage requirements in the request and a storage solution predictor model trained to predict storage classes using application storage requirements and select a storage profile from the storage class meeting the application storage requirements. As a result, the illustrative embodiments can provide a technical effect of increasing the performance in providing storage to meet storage requirements and service level objectives using a machine learning model in the form of storage solution predictor model to predict the storage class and select a storage profile meeting the storage requirements.

### BRIEF DESCRIPTION OF THE DRAWINGS

FIG. 1 is a block diagram of a computing environment in which illustrative embodiments can be implemented;

FIG. 2 is a block diagram of a storage environment in accordance with an illustrative embodiment;

FIG. 3 is an illustration of a storage profile in accordance with an illustrative embodiment;

FIG. 4 is an illustration of performance data in accordance with an illustrative embodiment;

FIG. 5 is an illustration of application storage requirements in accordance with an illustrative embodiment;

FIG. 6 is an illustration of dataflow for registering storage and training a storage solution predictor model to predict a storage solution in accordance with an illustrative embodiment;

FIG. 7 is a persistent volume claim in accordance with an illustrative embodiment;

FIG. 8 is a message flow diagram for persistent volume creation in accordance with an illustrative embodiment;

FIG. 9 is a flowchart of a process for managing storage for an application in accordance with an illustrative embodiment;

FIG. 10 is a flowchart of a process for managing storage for an application in accordance with an illustrative embodiment;

FIG. 11 is a flowchart of a process for creating a new storage in accordance with an illustrative embodiment;

FIG. 12 is a flowchart of a process for receiving a request for storage in accordance with an illustrative embodiment;

FIG. 13 is a flowchart of a process for returning a storage for use by an application in accordance with an illustrative embodiment;

FIG. 14 is a flowchart of a process for identifying a storage profile in accordance with an illustrative embodiment; and

FIG. 15 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

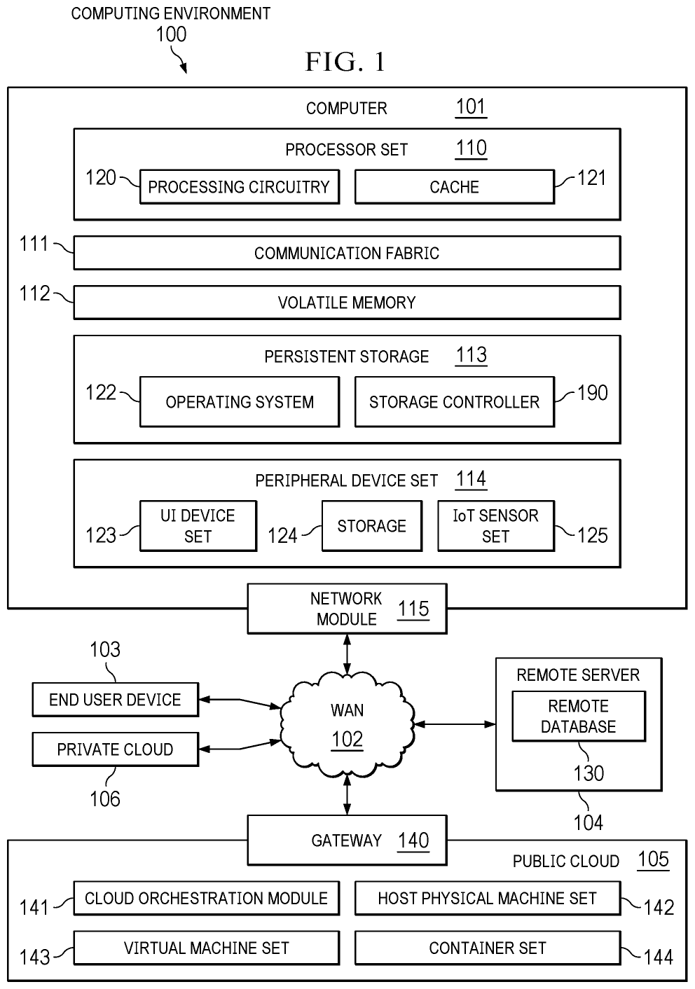

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as storage controller 190. In addition to storage controller 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and storage controller 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in storage controller 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in storage controller 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative examples recognize and take into account a number of different considerations as described herein. For example, a customer or user deploying applications in a container environment reviews and takes into account storage that is needed for an application. The user configures the storage and deploys interfaces such as container storage interface (CSI) plugins. Selecting the storage involves knowing application storage requirements and performance capabilities of the storage. Analyzing this information to determine the appropriate storage requires knowledge and performance data about the various storage options in a platform such as a container orchestration platform. Further, the user tests the selected storage by deploying an application in a test environment to perform application workloads using storage. The performance of the application workflow is monitored and analyzed to determine whether the application is performing as expected. If the application is not performing as expected, then the user selects another storage from the storage options available for the platform.

This process can be very time-consuming and requires knowledge and experience on the part of the user selecting the storage. Thus, the illustrative examples provide a computer implemented method, computer system, and computer program product for managing storage. A number of processor units receives a request for a storage for an application. The number of processor units identifies application storage requirements for the application in response to receiving the request for the storage for the application. The number of processor units identifies a storage profile based on the application storage requirements in the request. The storage profile describes the storage for use by the application. The number of processor units returns the storage having the profile for use by the application to access the storage. According to other illustrative embodiments, a computer system and a computer program product for managing storage are provided.

As used herein, “a number of” when used with reference to items, means one or more items. For example, “a number of processor units” is one or more processor units.

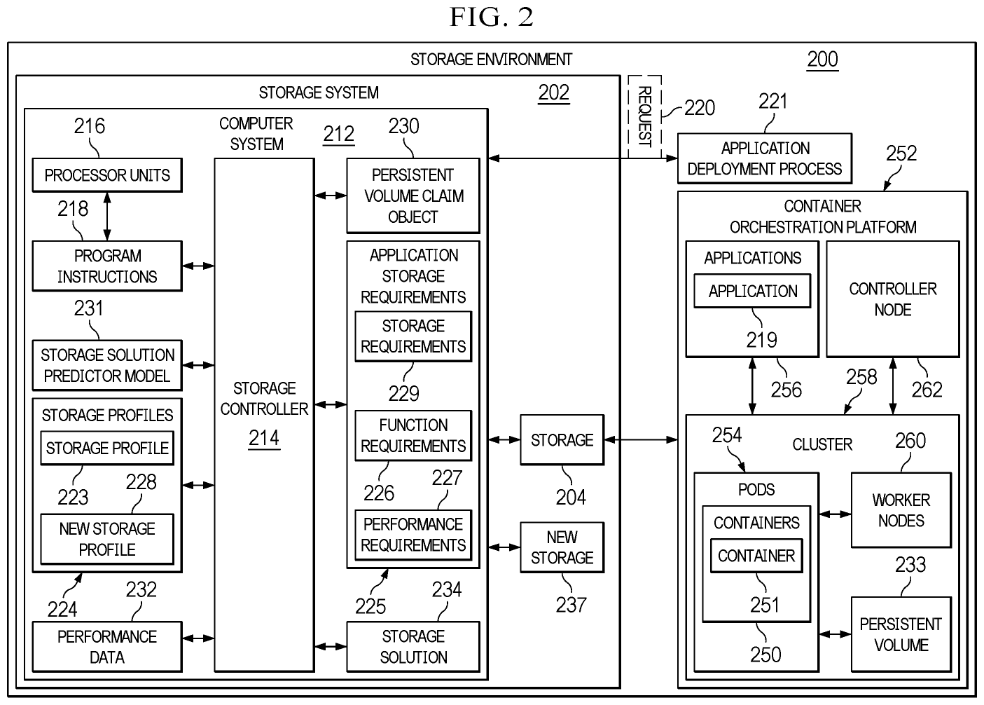

With reference now to FIG. 2, a block diagram of a storage environment is depicted in accordance with an illustrative embodiment. In this illustrative example, storage environment 200 includes components that can be implemented in hardware such as the hardware shown in computing environment 100 in FIG. 1.

In this illustrative example, storage system 202 can provide storage 204 for use in storage environment 200. In this example, storage 204 is a persistent storage. In other words, storage 204 can retain data when power is not supplied to storage 204. Storage 204 can take various forms. For example, storage 204 can be like storage, object storage, and file storage. Storage 204 can be implemented using hardware such as a hard disk, a storage area network, a network attached storage, a solid-state desk, or other suitable type.

As depicted, storage system 202 comprises computer system 212, storage controller 214, and storage 204. In this example, storage controller 214 is located in computer system 212.

Storage controller 214 can be implemented in software, hardware, firmware or a combination thereof. When software is used, the operations performed by storage controller 214 can be implemented in program instructions configured to run on hardware, such as a processor unit. When firmware is used, the operations performed by storage controller 214 can be implemented in program instructions and data and stored in persistent memory to run on a processor unit. When hardware is employed, the hardware can include circuits that operate to perform the operations in storage controller 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program instructions that operate a computer. A processor unit can be implemented using processor set 110 in FIG. 1. When the number of processor units 216 executes program instructions 218 for a process, the number of processor units 216 can be one or more processor units that are on the same computer or on different computers. In other words, the process can be distributed between processor units 216 on the same or different computers in computer system 212.

Further, the number of processor units 216 can be of the same type or different type of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, storage system 202 can provide storage 204 for use in a container environment such as container orchestration platform 252. In this example, storage 204 can be used by applications 256 in container orchestration platform 252 to process workloads.

Container orchestration platform 252 can be, for example, a Kubernetes® architecture, environment, or the like. However, it should be understood that description of illustrative examples using Kubernetes is meant as an example architecture only and not as a limitation on illustrative embodiments. Container orchestration platform 252 can also be referred to as a container orchestration system.

Container orchestration platform 252 provides a platform for automating deployment, scaling, and operations of applications 256. In this illustrative example, cluster 258 runs in a Kubernetes® architecture, environment, or the like. However, it should be understood that description of illustrative examples using Kubernetes is meant as an example architecture only and not as a limitation on the illustrative embodiments.

Container orchestration platform 252 provides a platform for automating deployment, scaling, and operations of applications 256. Container orchestration platform 252 also provides automatic deployment, scaling, and operations of pods 254. Each pod in pods 254 comprises a number of containers 250 running application workloads for applications 256 across cluster 258 of worker nodes 260.

These worker nodes 260 are also referred to as host nodes or minions. While the term “pod” is generally used in the Kubernetes paradigm, the term as used herein is not limited to that environment but rather refers to any grouping of a number of containers 250 where workloads are deployed and hold the running applications, libraries, and their dependencies.

A container is a standard unit of software for an application that packages up program instructions and all its dependencies, so the application can run on multiple computing environments. A container isolates software from the environment in which the container runs and ensures that the container works uniformly in different environments. A container for an application can share the operating system kernel on a machine with other containers for other applications. As a result, an operating system is not required for each container running on the machine.

Controller node 262 corresponds to cluster of worker nodes 260 that performs customer application workloads. Controller node 262 receives and tracks service requests from client device users requesting performance of services corresponding to applications 256. Controller node 262, which is a main controlling unit of cluster 258 of worker nodes 260, manages a customer application for cluster 258 and directs communication across worker nodes 260 in cluster 258. A worker node in worker nodes 260 is a machine, either physical or virtual, where containers for applications are deployed. While the terms “controller node” and “worker node” are generally used in the Kubernetes paradigm, these terms as used herein are not limited to that environment but rather refer to any type of nodes that are capable of controlling and running applications 256.

In one illustrative example, container orchestration platform 252 can be implemented as a satellite location. With this type of implementation, the satellite location is a representation of an environment that can be located in an infrastructure provider such as on premises data center or cloud. The locations can be made up of computer processing resources that reside in the infrastructure provider or even locally for the customer.

Storage controller 214 can provide storage 204 for use by applications 256 and container orchestration platform 252. Applications 256 can use storage 204 to store data for use in processing application workloads.

In this illustrative example, storage controller 214 receives request 220 for storage 204 for an application. When container orchestration platform 252 is a Kubernetes platform, request 220 can be a persistent volume claim.

In this example, the request can be for a storage solution for use by application 219 in applications 256 located in container orchestration platform 252. This request can be generated by deployment process 221 that deploys applications 256 in containers 250. For example, storage controller 214 can receive request 220 from application deployment process 221 that deploys application 219 in container 251 in container orchestration environment 252. In this example, request 220 can be a persistent volume claim when application 219 is deployed in a container environment such as container orchestration platform 252.

In this illustrative example, storage controller 214 identifies application storage requirements 225 for application 219 in response to receiving request 220 for storage 204 for application 219. Storage controller 214 identifies storage profile 223 in storage profiles 224 based on application storage requirements 225 for application 219. Storage profile 223 describes storage 204 for use by application 219.

Further in this example, storage controller 214 identifies storage profile 223 using storage solution predictor model 231. In this example, storage solution predictor model 231 is a storage machine learning model that predicts storage solution 234 for application 219 based on application storage requirements 225.

As depicted, storage solution predictor model 231 has been trained using storage profiles 224 and performance data 232. Performance data 232 describes performance metrics for storage 204. In this example, performance data 232 is present for each storage in storage profiles 224. Performance data 232 can include, for example, at least one of input/output operations per second (IOPS), a throughput, a latency, or other performance metrics measured for the performance of storage. In this example, performance data 232 for a particular storage can be linked to the corresponding storage profile in storage profiles 224. For example, a name or unique identifier can be used in storage profiles 224 and in performance data 232 to associate the performance data 232 with storage profiles 224.

In this illustrative example, storage solution predictor model 231 is a machine learning model. This machine learning model can be, for example, a random forest tree model, an artificial neural network, or some other suitable type of machine learning model. As depicted, storage solution predictor model 231 can recommend storage solution 234 in response to receiving application storage requirements 225 as an input.

In this illustrative example, application storage requirements 225 comprises storage requirements 229, function requirements 226 and performance requirements 227 for application 219. Storage requirements 229 is the amount of storage space. Function requirements 226 describe functions in storage 204. For example, the functions can include at least one of encryption, snapshot, clone, a storage size, an input/output type, an input/output size, a storage type, or other functions for storage 204. The storage type can be, for example, block, file, or object.

Performance requirements 227 describe performance of storage 204. In this example, performance requirements 227 can include at least one of the input/output operations per second (IOPS), a throughput, a latency, or other performance metrics describing the performance of storage 204.

Storage controller 214 can identify storage profile 223 through using storage solution 234 returned by storage solution predictor model 231. In some cases, a match may not be present between storage solution 234 in storage profiles 224. In this case, storage profile 223 can be identified from storage profiles 224 as a profile having the closest match to storage solution 234. In other words, a best fit storage can be identified.

In another illustrative example, storage controller 214 can create new storage 237 that meets application storage requirements 225 in response to an absence of the storage profile 223 meeting application storage requirements 225. In one illustrative example, new storage 237 can be a storage volume for storage 204. When container orchestration platform 252 is a Kubernetes platform, storage controller 214 can also include a controller storage interface (CSI) storage controller to provision volumes in storage 204. Storage controller 214 creates new storage profile 228 based on new storage 237.

Storage controller 214 returns storage 204 having profile 223 for use by application 219 to access storage 204. In this example, application 219 is used in container 251 in container orchestration platform 252. Storage 204 can be accessed by returning persistent volume claim object 230 for storage 204 having storage profile 223. Storage profile 223 is the profile identified for application 219 based on application storage requirements 225. In this example, application 219 uses persistent volume claim object 230 to access the storage 204 using the information in persistent volume claim object 230. In this example, storage 204 is a physical storage connected to persistent volume 233 and application 219 can be provided access to storage 204 through persistent volume 233 when application 219 is deployed in a container.

In this manner, the selection of storage 204 for applications 256 in container orchestration platform 252 can be made without user input. Further, the storage controller 214 to select storage 204 can be performed more accurately because a reliance a user having knowledge about storage 204 is unnecessary. In this illustrative example, this selection of storage 204 for application 219 can be performed by the deployment process without needing user input. As result, in addition to increase accuracy in selecting of storage 204 for application 219, the deployment of application 219 can be performed more quickly as compared to current techniques that require the user to select the storage. In these examples, the availability of storage 204 is not always known prior to deploying applications 256. Additionally, the types of storage available for container orchestration platform 252 can change over time. As result, application 219 can be redeployed by application deployment process 221 in response to a newer storage having at least one of better functionality for meeting function requirements 226 or better performance for meeting performance requirements 227 for application 219.

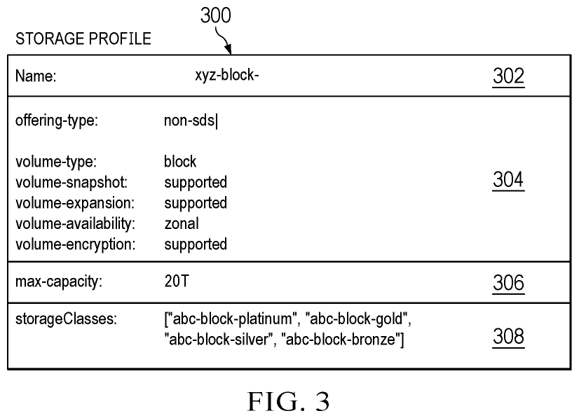

With reference next to FIG. 3, an illustration of a storage profile is depicted in accordance with an illustrative embodiment. In this illustrative example, storage profile 300 is an example of storage profile 223 in FIG. 2.

In this example, storage profile 223 is an example of a storage profile for a storage that can be used by an application in a container. Storage profile 300 can be generated when a storage is registered for use by a system such as container orchestration platform 252 in FIG. 2.

As depicted, storage profile 300 comprises name 302, functions 304, and capacity 306. Name 302 is a unique identifier for the storage. This unique identifier can also be used to identify performance data for the storage.

Functions 304 in storage profile 300 identify functions provided by the storage. In this example, storage functions include block, snapshot, expansion, zone availability, and encryption. As depicted, capacity 306 indicates the maximum capacity of the storage as being 20 TB.

In this example, storage profile 300 also includes storage classes 308. Storage classes 308 describes one or more classes for storage profile 300. This class storage can be used in container orchestration platform 252 to describe classes of storage offered by container orchestration platform 252.

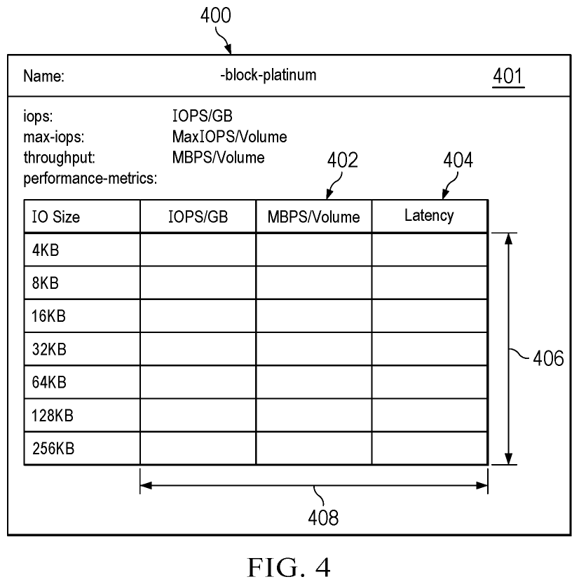

Turning to FIG. 4, an illustration of performance data is depicted in accordance with an illustrative embodiment. In this example, performance data 400 is an example of performance data 232 in FIG. 2. As depicted, performance data 400 includes name 401 and performance metrics 402. Name 401 is a unique identifier for the storage. This name can be used to locate or identify the profile for the storage.

In this example, performance metrics 402 are located in table 404. Performance metrics 402 identifies different types of performance data for different input-output sizes. As depicted, rows 406 identify the input-output size and columns 408 identify the type of performance metric. In this example, the performance metrics include maximum input/output operations per second in IOPS/GB, maximum throughput in MBPS/Volume, and latency in microseconds.

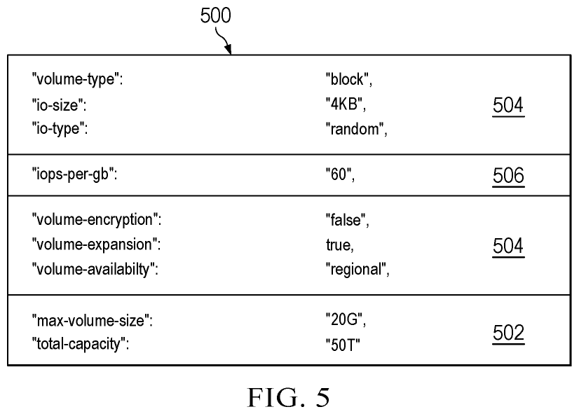

Next in FIG. 5, an illustration of application storage requirements is depicted in accordance with an illustrative embodiment. Application storage requirements 500 is an example of application storage requirements 225 in FIG. 2.

As depicted, application storage requirements 500 comprises storage requirements 502, function requirements 504, and performance requirements 506. In this example, storage requirements 502 identify a maximum volume size 20 GB with a total capacity of 50 TB. Function requirements 504 indicate that volume expansion and regional volume availability are required. Volume encryption is not desired in this example. Function requirements 504 also include volume type as block, IO size as 4 KB and IO type as random. When the container orchestration platform is a Kubernetes platform, these storage requirements and function requirements can be storage attributes in a persistent volume claim (PVC).

When the request is made using a container orchestration platform, the request can be in the form of a persistent volume claim. These requirements are attributes that can be placed in the persistent volume claim that is used to predict the best fit storage class or the application in a container orchestration environment. In this illustrative example, the application storage requirements can be added to a persistent volume claim. In other words, currently available persistent volume claims do not include application storage requirements. The addition of these requirements enables identifying a storage profile for having the requested application storage requirements.

In one illustrative example, one or more technical solutions are present that overcome a technical problem with selecting storage solutions for applications. As a result, one or more technical solutions may provide a technical effect in enabling selecting a storage solution that meets the requirements for application workloads run by applications. The selection can be performed using a registration system that identifies characteristics of the storage for storage profile and determines generates performance data for the performance of the storage. This storage profile and performance data for the storage can be used to train the machine learning model to predict storage solutions. In response receiving application storage requirements for application, a storage solution can be predicted for a storage that can be used by the application.

This process can be employed in different storage environments. One illustrative example is a container orchestration platform in which applications are deployed and containers. The storage for an application can be selected for use in deploying the application into a container.

Computer system 212 can be configured to perform at least one of the steps, operations, or actions described in the different illustrative examples using software, hardware, firmware or a combination thereof. As a result, computer system 212 operates as a special purpose computer system in which storage controller 214 in computer system 212 enables selecting storage for applications. In particular, storage controller 214 transforms computer system 212 into a special purpose computer system as compared to currently available general computer systems that do not have storage controller 214.

In the illustrative example, the use of storage controller 214 in computer system 212 integrates processes into a practical application for method selecting storage for applications in a manner that increases the performance of computer system 212. For example, with the selection of storage for an application, increased performance can occur for that application as compared to using current techniques. The different illustrative examples can identify a storage that provides increased performance by taking into account the performance requirements and the performance metrics for available storage. The illustration of storage environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, storage controller 214 can be located in one or more nodes such as controller node 262 and worker nodes 260 in container orchestration platform 252. Further, multiple instances of storage controller 214 can be present that are located in the different nodes such as worker nodes 260.

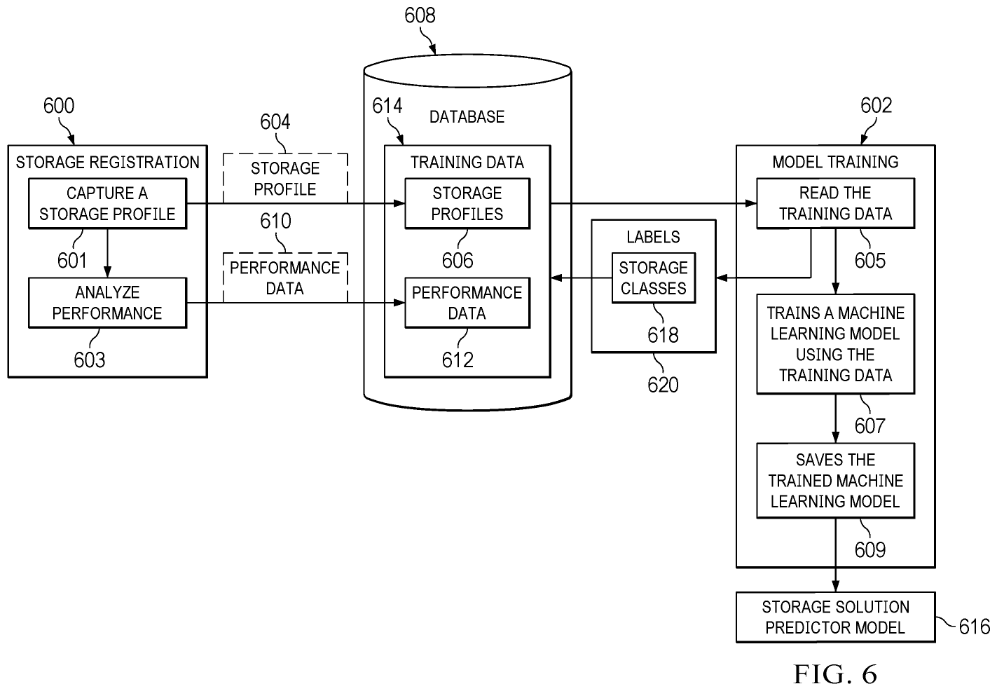

Turning now to FIG. 6, an illustration of dataflow for registering storage and training a storage solution predictor model to predict a storage solution is depicted in accordance with an illustrative embodiment. In this illustrative example, storage registration 600 and model training 602 occur to train a machine learning model.

In this example, storage registration 600 captures storage profile 604 (step 601) as part of registering a new storage. In this example, the storage profile is stored with storage profiles 606 in database 608.

Storage registration 600 also analyzes the performance of the storage (step 603). This analysis generates performance data 610 that is stored with performance data 612 for other registered storage in database 608.

In this example, storage profile 604 and performance data 612 form training data 614. Model training 602 reads the training data 614 (step 605). In step 605, storage profiles 604 and performance data 612 can be clustered into groups. This clustering can be used to create storage classes 618. Each of these groups can form a storage class.

In this example, the groupings of storage profiles and stored performance in storage classes 618 in training data 614 can be used as labels 620 for training data 614. In other illustrative examples, the clustering and creation of storage classes can be performed before training with the labels for the storage classes be stored with storage profiles 606 and performance data 612.

Model training 602 then trains a machine learning model using training data 614 (step 607). The machine learning model in step 607 can be, for example, a random forest tree model, an artificial neural network, or some other suitable type of machine learning model. Model training 602 saves the trained machine learning model (step 609). This trained machine learning model is storage solution predictor model 616 in this example.

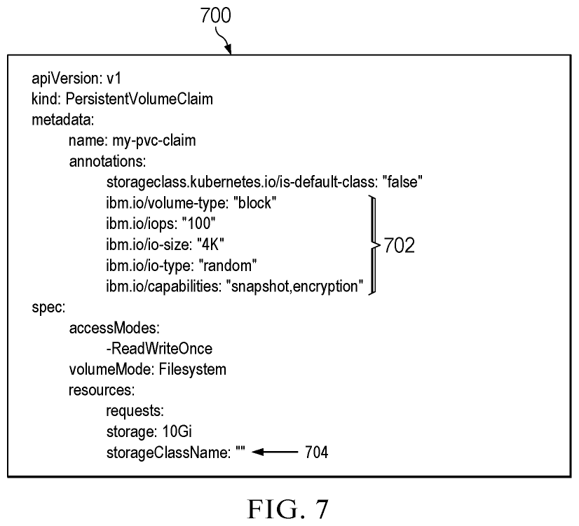

In FIG. 7, a persistent volume claim is depicted in accordance with an illustrative embodiment. In this example, persistent volume claim 700 is an example of an implementation for request 220 when an illustrative example is implemented in a container orchestration platform in the form of a Kubernetes platform.

As depicted, persistent volume claim 700 is a persistent volume claim that includes storage attributes 702. Storage attributes 702 are new attributes not used in current persistent volume claims that do not use processes in the illustrative examples. Storage attributes 702 can define storage requirements and functional requirements or the storage for an application. These storage attributes are used to identify storage for use in application.

In response to identifying a storage for the application, storage class 704 can be added or updated in persistent volume claim 700. For example, if storage class 704 is a default storage class, that storage class can be updated with the storage class identified for attributes 702. In this example, storage class 704 is a storage class for a specific type of storage. In this example, storage class 704 identifies storage having attributes 702.

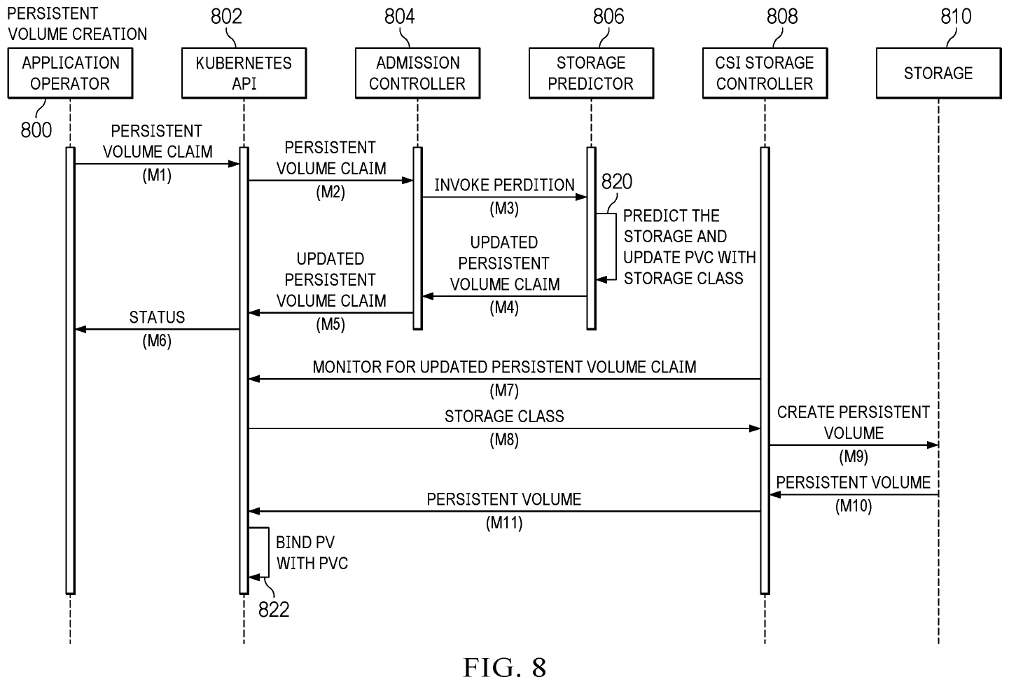

With reference to FIG. 8, a message flow diagram for persistent volume creation is depicted in accordance with an illustrative embodiment. In this example, the message flow for persistent volume creation is for components in a container orchestration platform such as a Kubernetes platform. As depicted, the components include application operator 800, Kubernetes API 802, admission controller 804, storage predictor 806, CSI storage controller 808, and storage 810.

In this example, application operator 800 is a deployment process such as application deployment process 221 in FIG. 2. Kubernetes API 802 is an application programming interface to components in a control plane in a Kubernetes platform. This control plane manages worker nodes in pods in a cluster. Admission controller 804 is a component in the control plane that intercepts the request to Kubernetes API 802 and invokes a user defined webhook process that uses storage predictor 806 to examine and change the request content. Admission controller 804 is an example a component in storage controller 214 in FIG. 2.

Storage predictor 806 predicts a storage class for an application based on storage attributes in a persistent volume claim. Storage predictor 806 is an example storage solution predictor model 231 in FIG. 2. This component is a new component that enables selecting storage for an application based on storage requirements and functional requirements specified storage attributes in a persistent volume claim.

In this example, CSI storage controller 808 is an interface driver that can be used to create and mount persistent volumes in storage 810. Storage 810 is a hardware storage in which persistent volumes can be created for use by different applications deployed in containers in a Kubernetes platform. Storage 810 can be, for example, in an external storage system or a software defined storage system (SDS).

In this example, the message flow begins with application operator 800 sending a persistent volume claim to Kubernetes API 802 (message m1). This message is a request to create a persistent volume for use by an application and can be persistent volume claim 700 in FIG. 7 in this example.

In this example, admission controller 804 intercepts the persistent volume claim (message m2) and invokes storage predictor 806 to predict a storage (message m3). In this example, storage predictor 806 predicts the storage based on storage attributes 702 in persistent volume claim 700 and updates storage class 704 in persistent volume claim 700 with the storage class corresponding to the storage identified using storage attributes 702 to form an updated system volume claim (step 820). Storage predictor 806 returns an updated persistent volume claim to admission controller 804 (message m4). This updated persistent volume claim is sent by admission controller 804 to Kubernetes API 802 (message m5). Kubernetes API 802 receives returns a status to application operator 800 (message m6). In message m6, the status is a message that contains error in case of a request failure or it contains “<PVC name> created” on a successful PVC request acceptance.

In this example, CSI storage controller 808 monitors for the updated persistent volume claim through monitoring Kubernetes API 802 (message m7). In response to detecting the updated persistent volume claim, CSI storage controller 808 obtains storage class in the updated persistent volume claim (message m8). CSI storage controller 808 sends a request to storage 810 to create a to create a persistent volume in storage 810 (message m9). In this example, storage 810 returns volume details in response to creating a persistent volume from the request sent by CSI storage controller 808 (message m10). The details on the persistent volume claim are sent to Kubernetes API 802 by CSI storage controller 808 (message m11). Kubernetes API 802 binds the persistent volume (PV) with the persistent volume claim (PVC) (step 822). In step 822, binding persistent volume with the persistent volume claim is a process to assign or map a persistent volume with persistent volume claim. Once the persistent volume claim is bound to persistent volume the persistent volume claim is ready for use by the application.

The illustration of the message flow in FIG. 8 is provided as an example of one manner in which storage can be allocated to an application for use in a Kubernetes platform. This illustration is not meant to limit the manner in which other illustrative examples can be implemented. For example, this message flow can be implemented in other container orchestration platforms for any platform in which applications are deployed and containers. Further, although the illustrative example describes the provisioning of persistent volumes, other illustrative examples can be applied to provision or provide volumes or storage that are not persistent.

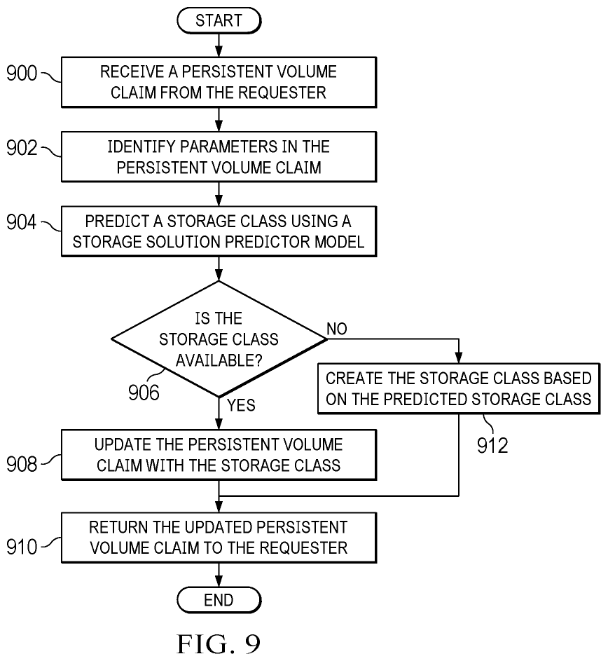

Turning next to FIG. 9, a flowchart of a process for managing storage for an application is depicted in accordance with an illustrative embodiment. The process illustrated in FIG. 9 can be implemented in hardware, software, or both. When implemented in software, the process can take the form of program instructions that are run by one of more processor units located in one or more hardware devices in one or more computer systems. For example, the process can be implemented in storage controller 214 in computer system 212 in FIG. 2. This process can be implemented for selecting storage for applications 256 deployed in container orchestration platform 252 to FIG. 2.

The process begins by receiving a persistent volume claim from the requester (step 900). The persistent volume claim is a request use in the container orchestration platform such as Kubernetes to request persistent storage volumes. In this example, the requester can be an application deployment process that is operating to deploy an application.

The process identifies parameters in the persistent volume claim (step 902). In this example, these parameters are application storage requirements such as application storage requirements 225 in FIG. 2 and application storage requirements 500 in FIG. 5.

The process predicts a storage class using a storage solution predictor model (step 904). In this example, the storage class is a storage solution that is selected for use by the application based on the application storage requirements. A number of different types of storage can be present in a storage class. In the illustrative example, the different types of storage can all meet the application storage requirements in the persistent volume claim.

A determination is made as to whether the storage class is available (step 906). If the storage class is available, the process updates the persistent volume claim with the storage class (step 908). The process then returns the updated persistent volume claim to the requester (step 910). The process terminates thereafter. The requester can be an admission controller.

With reference again to step 906, if the storage class is not available, the process creates the storage class based on the predicted storage class (step 912). The process then proceeds to step 910 as described above. In this illustrative example, in creating a new storage class, a new storage profile is created for inclusion with other storage profiles. As result, the storage for the storage class can be made available to other applications. In this example, a storage is created using the new storage profile for the new storage class.

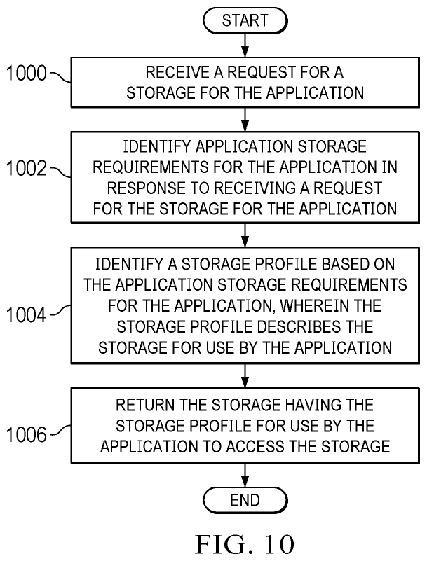

Turning next to FIG. 10, a flowchart of a process for managing storage for an application is depicted in accordance with an illustrative embodiment. The process in FIG. 10 can be implemented in hardware, software, or both. When implemented in software, the process can take the form of program instructions that are run by one of more processor units located in one or more hardware devices in one or more computer systems. For example, the process can be implemented in storage controller 214 in computer system 212 in FIG. 2.

The process begins by receiving a request for a storage for the application (step 1000). The process identifies application storage requirements for the application in response to receiving a request for the storage for the application (step 1002).

The process identifies a storage profile based on the application storage requirements for the application, wherein the storage profile describes the storage for use by the application (step 1004). The process returns the storage having the storage profile for use by the application to access the storage (step 1006). The process terminates thereafter.

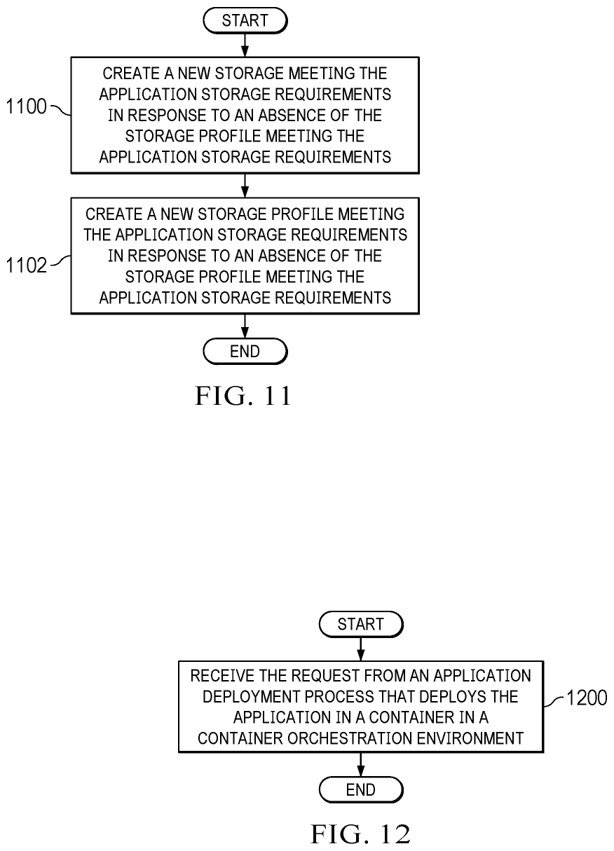

Turning now to FIG. 11, a flowchart of a process for creating a new storage is depicted in accordance with an illustrative embodiment. The process illustrated in FIG. 11 is an example of additional steps that can be performed with the steps in FIG. 10.

The process begins by creating a new storage meeting the application storage requirements in response to an absence of the storage profile meeting the application storage requirements (step 1100). The process creates a new storage profile meeting the application storage requirements in response to an absence of the storage profile meeting the application storage requirements (step 1102). The process terminates thereafter.

With reference to FIG. 12, a flowchart of a process for receiving a request for storage is depicted in accordance with an illustrative embodiment. The process in this figure is an example of one implementation for step 1000 in FIG. 10. This process can be used with a container orchestration environment.

The process receives the request from an application deployment process that deploys the application in a container in a container orchestration environment (step 1200). The process terminates thereafter.

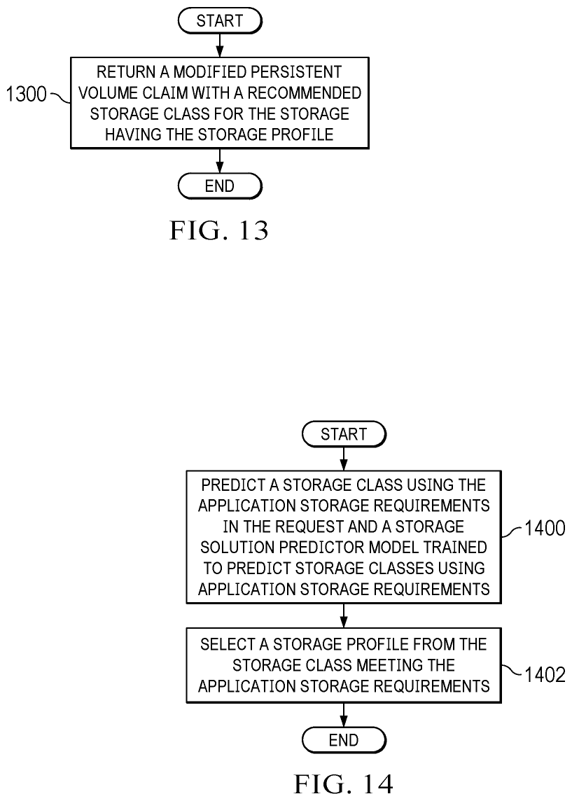

In FIG. 13, a flowchart of a process for returning a storage for use by an application is depicted in accordance with an illustrative embodiment. The process in this flowchart is an example of one implementation for step 1006 in FIG. 10. In this example, the request is a persistent volume claim and the application is used in a container in a container orchestration environment. The storage is a physical storage connected to a persistent volume and the application uses the uses the persistent volume for the storage class to access the storage.

The process returns a modified persistent volume claim with a recommended storage class for the storage having the storage profile (step 1300). The process terminates thereafter. In this step, the recommended storage class can be used to provide the application with access to the persistent volume for the storage when the application is deployed in a container.

With reference next to FIG. 14, a flowchart of a process for identifying a storage profile is depicted in accordance with an illustrative embodiment. The process in this flowchart is an example of an implementation for step 1004 in FIG. 10.

The process begins by predicting a storage class using the application storage requirements in the request and a storage solution predictor model trained to predict storage classes using application storage requirements (step 1400). The process selects a storage profile from the storage class meeting the application storage requirements (step 1402). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

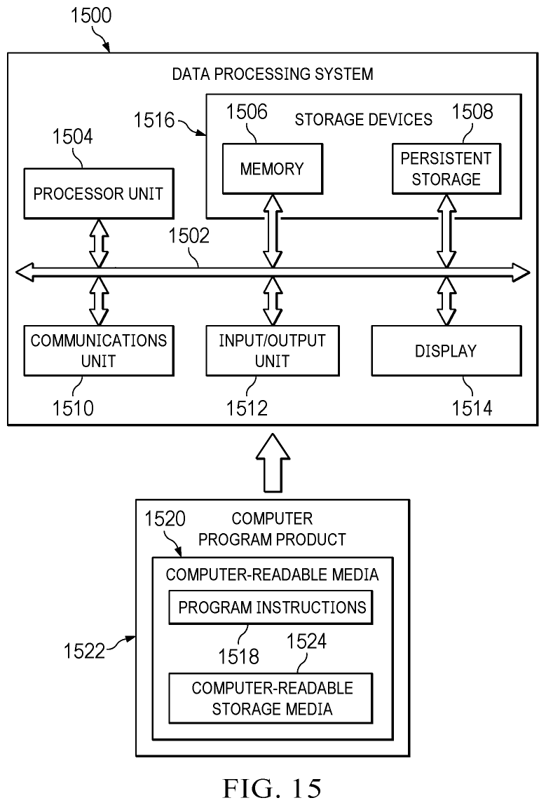

Turning now to FIG. 15, a block diagram of a data processing system is depicted in accordance with an illustrative embodiment. Data processing system 1500 can be used to implement computers and computing devices in computing environment 100 in FIG. 1. Data processing system 1500 can also be used to implement computer system 212 in FIG. 2. In this illustrative example, data processing system 1500 includes communications framework 1502, which provides communications between processor unit 1504, memory 1506, persistent storage 1508, communications unit 1510, input/output (I/O) unit 1512, and display 1514. In this example, communications framework 1502 takes the form of a bus system.

Processor unit 1504 serves to execute instructions for software that can be loaded into memory 1506. Processor unit 1504 includes one or more processors. For example, processor unit 1504 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1504 can may be implemented using one or more heterogeneous processor systems in which a main processor is present with secondary processors on a single chip. As another illustrative example, processor unit 1504 can be a symmetric multi-processor system containing multiple processors of the same type on a single chip.

Memory 1506 and persistent storage 1508 are examples of storage devices 1516. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1516 may also be referred to as computer readable storage devices in these illustrative examples. Memory 1506, in these examples, can be, for example, a random-access memory or any other suitable volatile or non-volatile storage device. Persistent storage 1508 may take various forms, depending on the particular implementation.

For example, persistent storage 1508 may contain one or more components or devices. For example, persistent storage 1508 can be a hard drive, a solid-state drive (SSD), a flash memory, a rewritable optical disk, a rewritable magnetic tape, or some combination of the above. The media used by persistent storage 1508 also can be removable. For example, a removable hard drive can be used for persistent storage 1508.

Communications unit 1510, in these illustrative examples, provides for communications with other data processing systems or devices. In these illustrative examples, communications unit 1510 is a network interface card.

Input/output unit 1512 allows for input and output of data with other devices that can be connected to data processing system 1500. For example, input/output unit 1512 may provide a connection for user input through at least one of a keyboard, a mouse, or some other suitable input device. Further, input/output unit 1512 may send output to a printer. Display 1514 provides a mechanism to display information to a user.

Instructions for at least one of the operating system, applications, or programs can be located in storage devices 1516, which are in communication with processor unit 1504 through communications framework 1502. The processes of the different embodiments can be performed by processor unit 1504 using computer-implemented instructions, which may be located in a memory, such as memory 1506.

These instructions are referred to as program instructions, computer usable program instructions, or computer readable program instructions that can be read and executed by a processor in processor unit 1504. The program instructions in the different embodiments can be embodied on different physical or computer readable storage media, such as memory 1506 or persistent storage 1508.

Program instructions 1518 are located in a functional form on computer readable media 1520 that is selectively removable and can be loaded onto or transferred to data processing system 1500 for execution by processor unit 1504. Program instructions 1518 and computer readable media 1520 form computer program product 1522 in these illustrative examples. In the illustrative example, computer readable media 1520 is computer readable storage media 1524.

Computer readable storage media 1524 is a physical or tangible storage device used to store program instructions 1518 rather than a medium that propagates or transmits program instructions 1518. Computer readable storage media 1524, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1518 can be transferred to data processing system 1500 using a computer readable signal media. The computer readable signal media are signals and can be, for example, a propagated data signal containing program instructions 1518. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1520” can be singular or plural. For example, program instructions 1518 can be located in computer readable media 1520 in the form of a single storage device or system. In another example, program instructions 1518 can be located in computer readable media 1520 that is distributed in multiple data processing systems. In other words, some instructions in program instructions 1518 can be located in one data processing system while other instructions in program instructions 1518 can be located in one data processing system. For example, a portion of program instructions 1518 can be located in computer readable media 1520 in a server computer while another portion of program instructions 1518 can be located in computer readable media 1520 located in a set of client computers.

The different components illustrated for data processing system 1500 are not meant to provide architectural limitations to the manner in which different embodiments can be implemented. In some illustrative examples, one or more of the components may be incorporated in or otherwise form a portion of, another component. For example, memory 1506, or portions thereof, may be incorporated in processor unit 1504 in some illustrative examples. The different illustrative embodiments can be implemented in a data processing system including components in addition to or in place of those illustrated for data processing system 1500. Other components shown in FIG. 15 can be varied from the illustrative examples shown. The different embodiments can be implemented using any hardware device or system capable of running program instructions 1518.

Thus, the illustrative embodiments of the present invention provide a computer implemented method, computer system, and computer program product for managing storage. A number of processor units receives a request for a storage for an application. The number of processor units identifies application storage requirements for the application in response to receiving the request for the storage for the application. The number of processor units identifies a storage profile based on the application storage requirements in the request. The storage profile describes the storage for use by the application. The number of processor units returns the storage having the profile for use by the application to access the storage. According to other illustrative embodiments, a computer system and a computer program product for managing storage are provided.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for managing storage for an application, the computer implemented method comprising:
receiving, by a number of processor units, a request for a storage for the application;
identifying, by the number of processor units, application storage requirements for the application in response to receiving the request for the storage for the application;
identifying, by the number of processor units, a storage profile based on the application storage requirements for the application, wherein the storage profile describes the storage for use by the application; and
returning, by the number of processor units, the storage having the storage profile for use by the application to access the storage.

2. The computer implemented method of claim 1 further comprising:
creating, by the number of processor units, a new storage meeting the application storage requirements in response to an absence of the storage profile meeting the application storage requirements; and
creating, by the number of processor units, a new storage profile meeting the application storage requirements in response to the absence of the storage profile meeting the application storage requirements.

3. The computer implemented method of claim 1, wherein receiving, by the number of processor units, the request for the storage for the application comprises:
receiving, by the number of processor units, the request from an application deployment process that deploys the application in a container in a container orchestration environment.

4. The computer implemented method of claim 1, wherein the request is a persistent volume claim and wherein the application is used in a container orchestration environment and wherein returning, by the number of processor units, the storage having the storage profile for use by the application to access the storage comprises:
returning, by the number of processor units, a modified persistent volume claim with a recommended storage class for the storage having the storage profile.

5. The computer implemented method of claim 4, wherein the storage is a physical storage connected to the persistent volume and wherein the application uses the persistent volume for the storage class to access the storage.

6. The computer implemented method of claim 1, wherein identifying, by the number of processor units, the storage profile based on the application storage requirements in the request comprises:
predicting, by the number of processor units, a storage class using the application storage requirements in the request and a storage solution predictor model trained to predict storage classes using the application storage requirements; and
selecting, by the number of processor units, the storage profile from the storage class meeting the application storage requirements.

7. The computer implemented method of claim 6 further comprising:
training, by the number of processor units, the storage solution predictor model using storage profiles and performance data for a plurality of storage.

8. The computer implemented method of claim 1, wherein the application storage requirements comprise storage requirements, function requirements, and performance requirements.

9. A computer system comprising:
a number of processor units, wherein the number of processor units executes program instructions to:
receive a request for a storage for an application;
identify application storage requirements for the application in response to receiving the request for the storage for the application;
identify a storage profile based on the application storage requirements for the application, wherein the storage profile describes the storage for use by the application; and
return the storage having the storage profile for use by the application to access the storage.

10. The computer system of claim 9, wherein the number of processor units executes program instructions to:
create a new storage meeting the application storage requirements in response to an absence of the storage profile meeting the application storage requirements; and
create a new storage profile meeting the application storage requirements in response to the absence of the storage profile meeting the application storage requirements.

11. The computer system of claim 9, wherein in receiving the request for the storage for the application, the number of processor units executes program instructions to:
receive the request from an application deployment process that deploys the application in a container in a container orchestration environment.

12. The computer system of claim 9, wherein the request is a persistent volume claim and wherein the application is used in a container orchestration environment and wherein in returning the storage having the storage profile for use by the application to access the storage, the number of processor units executes program instructions to:
return a modified persistent volume claim with a recommended storage class for the storage having the storage profile.

13. The computer system of claim 12, wherein the storage is a physical storage connected to the persistent volume and wherein the application uses the persistent volume for the storage class to access the storage.

14. The computer system of claim 9, wherein in identifying the storage profile based on the application storage requirements in the request, the number of processor units executes program instructions to:
predict a storage class using the application storage requirements in the request and a storage solution predictor model trained to predict storage classes using the application storage requirements; and
select the storage profile from the storage class meeting the application storage requirements.

15. The computer system of claim 14, wherein the number of processor units executes program instructions to:
train the storage solution predictor model using storage profiles and performance data for a plurality of storage.

16. The computer system of claim 9, wherein the application storage requirements comprise storage requirements, function requirements, and performance requirements.

17. A computer program product for managing storage for an application, the computer program product comprising a computer readable storage medium having program instructions embodied therewith, the program instructions executable by a computer system to cause the computer system to perform a method of:
receiving a request for a storage for the application;
identifying application storage requirements for the application in response to receiving the request for the storage for the application;
identifying a storage profile based on the application storage requirements for the application, wherein the storage profile describes the storage for use by the application; and
returning the storage having the storage profile for use by the application to access the storage.

18. The computer program product of claim 17 further comprising:
creating a new storage meeting the application storage requirements in response to an absence of the storage profile meeting the application storage requirements; and
creating a new storage profile meeting the application storage requirements in response to the absence of the storage profile meeting the application storage requirements.

19. The computer program product of claim 17 receiving the request for the storage for the application comprises:
receiving the request from an application deployment process that deploys the application in a container in a container orchestration environment.

20. The computer program product of claim 17, wherein the request is a persistent volume claim and wherein the application is used in a container orchestration environment and wherein returning the storage having the storage profile for use by the application to access the storage comprises:
returning a modified persistent volume claim with a recommended storage class for the storage having the storage profile.
